(19) United States
(12) Patent Application Publication
(10) Pub. No.: US 2007/0004849 A1
(43) Pub. Date: Jan. 4, 2007

(54) Method for the preliminary treatment of cellulose-containing textile

(76) Inventors: Karl Siemensmeyer, Frankenthal (DE); Steffen Gibs, Kottweiler-Schwanden (DE); Frank Funke, Ludwigshafen (DE); Andreas Bastian, Schauerberg (DE); Michael Gotsche, Mannheim (DE); Heinz Heissler, Frankenthal (DE); James David Carnahan, Niederkirchen (DE); Tanja Schneider, Bensheim (DE); Holger Schopke, Neckargemund (DE); Stefan Frenzel, Mannheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/573,808

(22) PCT Filed: Sep. 24, 2004
(86) PCT No.: PCT/EP04/10721

§ 371 Date: Mar. 28, 2006

(51) Int. Cl. C08F 8/30

(52) U.S. Cl. 524/555

(57) ABSTRACT

A process for pretreating cellulosic textile, which comprises the steps of: (a) treating cellulosic textile with a solution of polymer or copolymer obtainable by
(a1) polymerization or copolymerization of N-vinylamide of the general formula I 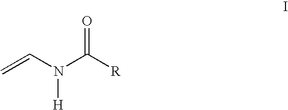 where
R is selected from hydrogen and C₁-C₁₀-alkyl, and (a2) partial hydrolysis if appropriate, (b) optionally drying the treated textile, and (c) optionally saponifying all or some of the amide groups, wherein at least one of the steps (a2) and (c) is carried out.

The present invention relates to a process for pretreating cellulosic textile, which comprises the steps of:
(a) treating cellulosic textile with a solution of polymer or copolymer obtainable by
   (a1) polymerization or copolymerization of N-vinylamide of the general formula I, 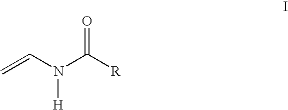
   where
   R is selected from hydrogen and C₁-C₁₀-alkyl, and
   (a2) partial hydrolysis if appropriate,
(b) optionally drying the treated textile, and
(c) optionally saponifying all or some of the amide groups,
   wherein at least one of the steps (a2) and (c) is carried out.

Cellulosic textile can be dyed by various processes. Dyeings with reactive, vat or direct dyes are customary today. However, it is a frequent observation that the degree of exhaustion, i.e., the fraction of dye which has gone onto the textile from the dyeing liquor, and also the fastness level of the dyeing leave something to be desired.

Especially reactive dyeings often yield a degree of exhaustion distinctly below 80%. One reason is that there are many cases where full reaction of the reactive system of the dye with the OH groups of the cellulose is not achieved. The rest of the dye gene-rally passes into a wastewater treatment plant.

A particular reason for the frequently unsatisfactory fastness level of the dyeing is the fact that not all the dye is adequately fixed. An observation with the use of textile is that unfixed dye gets washed off during the washes carried out by the consumer. Even apparently adequately fixed reactive dye can become washed off if the chemical bond between the reactive dye and the fiber is scissioned during the customary washing operations, which causes the washed textile to fade as well as staining of adjacent fabric.

The fastness level of the dyeings with reactive dyes in particular is currently often improved by using cationic aftertreating agents for dyed textile, but this is associated with additional steps in the dyeing operation or at the finishing stage, and accordingly adds costs.

It has further been proposed to apply cationic aftertreating agents and also polyethyleneamines to cellulosic textile prior to the actual dyeing operation. This application is effective in bringing about a distinctly more intensive dyeing (Bunt-Denim, TI/T 240 d, July 1993, BASF Aktiengesellschaft), but in many cases this produces an undesirable ring dyeing in which all or some fibers are dyed at the surface only and not evenly throughout the cross section. When rough dyed fibers are exposed to a mechanical stress, the dyeing tends to become mechanically removed and the fibers quickly acquire an undesirable appearance.

The present compound accordingly has for its object to provide a textile pretreatment process which avoids the disadvantages of the prior art and, more particularly, provides evenly through-dyed textile. A further object of the present invention is to provide a process by means of which the textile can be dyed without entailing excessive salt loads in the dyeing liquors to be disposed of.

We have found that these objectives are achieved by the process defined at the beginning.

Cellulosic textile in the framework of the present invention refers to cellulosic textile fibers, cellulosic textile intermediate and end products and finished articles manufactured therefrom which, as well as textiles for the apparel industry, also include for example carpets and other home textiles and also textile structures for industrial purposes. These also include unshaped structures such as for example staples, linear structures such as twine, filaments, yarns, lines, strings, laces, braids, cordage, threads and also three-dimensional structures such as for example felts, wovens, nonwovens and waddings. Cellulosic textiles can be of natural origin, for example cotton, wool or flax, or blend fabrics, for example with cotton-polyester, cotton-polyamide, the size of the cellulose fraction not being critical.

The present invention comprises treating cellulosic textile in a step (a) with a solution of polymer or copolymer obtainable by
(a1) polymerization or copolymerization of N-vinylamide of the general formula I 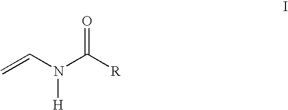
where
R is selected from C₁-C₁₀-alkyl, branched or preferably unbranched, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably unbranched C₁-C₄-alkyl such as methyl, ethyl, n-propyl, n-butyl; especially hydrogen
and (a2) partial hydrolysis if appropriate.

One embodiment of the present invention utilizes copolymers obtainable by copolymerization of N-vinylamide of the general formula I with at least one suitable comonomer, wherein copolymers can be random copolymers, block copolymers and specifically graft copolymers. Suitable comonomers include for example (meth)acrylates such as for example methyl acrylate, methyl methacrylate, ethyl acrylate, N-vinylpyrrolidone, N-vinylimidazole, ethyl methacrylate, ethylene, propylene, 1-butene or 1,3-butadiene.

Copolymers obtainable by copolymerization of N-vinylamide of the general formula I with at least one suitable comonomer in one embodiment comprise at least 20% by weight and preferably at least 30% by weight, based on copolymer, of N-vinylamide of the general formula I.

One embodiment of the present invention utilizes a solution of copolymer obtainable by copolymerization of

20 to 90% by weight of N-vinylamide of the general formula I and

10 to 80% by weight of comonomer selected from N-vinylpyrrolidone and N-vinylimidazole

and optional subsequent partial hydrolysis,

amounts in % by weight being based in each case on copolymer employed.

One embodiment of the present invention utilizes a solution of copolymer obtainable by copolymerization of

20 to 80% by weight of N-vinylamide of the general formula I

10 to 70% by weight of N-vinylimidazole and

10 to 70% by weight of N-vinylpyrrolidone

and optional subsequent partial hydrolysis,

amounts in % by weight being based in each case on copolymer employed.

Another embodiment of the present invention utilizes a solution of copolymer formed from at least two different monomers of the general formula I, wherein copolymers can be random copolymers, block copolymers and specifically graft copolymers.

A preferred embodiment of the present invention utilizes a solution of homopolymer of N-vinylformamide.

One embodiment of the present invention utilizes polymers or copolymers in step (a) which have a molecular weight M_{w} in the range from 10 000 to 1 000 000 g/mol, and preferably in the range from 30 000 to 400 000 g/mol, determined for example by gel permeation chromatography.

One embodiment of the present invention utilizes in step (a) such polymer or copolymer as is obtainable by polymerization or copolymerization of N-vinylamide of the general formula I and subsequent partial hydrolysis of the amide groups, for example with dilute aqueous alkali metal hydroxide solution or dilute aqueous alkali metal carbonate solution or dilute aqueous acid such as for example phosphoric acid or sulfuric acid, wherein for example 60 mol % or 30 mol % or 10 mol % of all amide groups can be hydrolyzed.

One embodiment of the present invention utilizes aqueous solution of the polymer or copolymer obtainable by polymerization or copolymerization of N-vinylamide of the general formula I in a concentration from 0.1% to 20% by weight and preferably from 0.5% to 5% by weight.

One embodiment of the present invention utilizes from 0.1% to 10% by weight and preferably from 2% to 8% by weight, based on cellulosic textile, of if appropriate partially hydrolyzed polymer or copolymer obtainable by polymerization or copolymerization of N-vinylamide of the general formula I.

Step (a) can be carried out one or more times in the framework of the present invention. Various polymers or copolymers may be utilized in this connection, at least one of which is obtainable by polymerization or copolymerization of N-vinylamide. But it is also possible to use the same polymer or copolymer as is obtainable by polymerization or copolymerization of N-vinylamide and if appropriate partial hydrolysis.

The treatment in step (a) can be carried out for example as per an exhaust process or a padding process.

To carry out step (a) in the manner of an exhaust process, the cellulosic textile to be pretreated can be pulled through a preferably aqueous liquor comprising a solution of polymer or copolymer obtainable by polymerization or copolymerization of N-vinylamide of the general formula I. Cellulosic textile to be pretreated is subsequently pulled through rollers to squeeze off excess solution.

To carry out step (a) in the manner of a padding process, commonly used machines can be employed. Preference is given to pad-mangles where the essential element is two rollers in press contact with each other, through which the cellulosic textile to be pretreated is led. The liquor containing solution of polymer or copolymer obtainable by polymerization or copolymerization of N-vinylamide of general formula I is filled in above the rollers and wets the textile. The pressure causes the textile to be squeezed off and ensures a constant add-on. There is another form of padding which employs one or more impregnating baths through which the cellulosic textile to be treated is pulled. The textile subsequently passes through a pad-mangle, and excess solution is squeezed off.

In one embodiment of the present invention the pretreatment in step (a) is performed in the presence of at least one fixative. Examples of suitable fixatives include the following:

urea-formaldehyde adducts and melamine-formaldehyde adducts, if appropriate in combination with inorganic salts such as for example MgCl₂.6H₂O or NH₄Cl, especially urea-formaldehyde-glyoxal condensates whose hydroxyl groups may have been partly or quantitatively etherified with methanol for example,

condensates of N,N′-dimethylurea with glyoxal,

isocyanates and/or their dimers or trimers, such as 4,4′-methylene(diphenyl isocyanate) MDI, hexamethylene diisocyanate HDI, isophorone diisocyanate, in each case free or blocked with 3,5-dimethylpyrazole, acetone oxime or sec-butanone oxime, for example, especially trimeric hexamethylene diisocyanate and trimeric isophorone diisocyanate, each free or blocked. Examples can be found in EP-B 0 206 059,

di-, tri- and polyepoxides, selected from polyamines, diamines, polyols, diols reacted for example with epichlorohydrin,

oligomeric carbodiimines,

di- and trialdehydes such as for example glutardialdehyde, glyoxal, dextran polyaldehydes, and also starch aldehydes, prepared for example in accordance with US 2001-0025102 A1;

epoxysilanes, prepared for example according to DE 35 28 006 and DE 41 28 894,

polyalkoxycarbonylamino derivatives

and also aziridine compounds such as e.g. trimethylolpropane tris(beta-aziridino)propionate.

Especially preferred di-, tri- and polyepoxides are 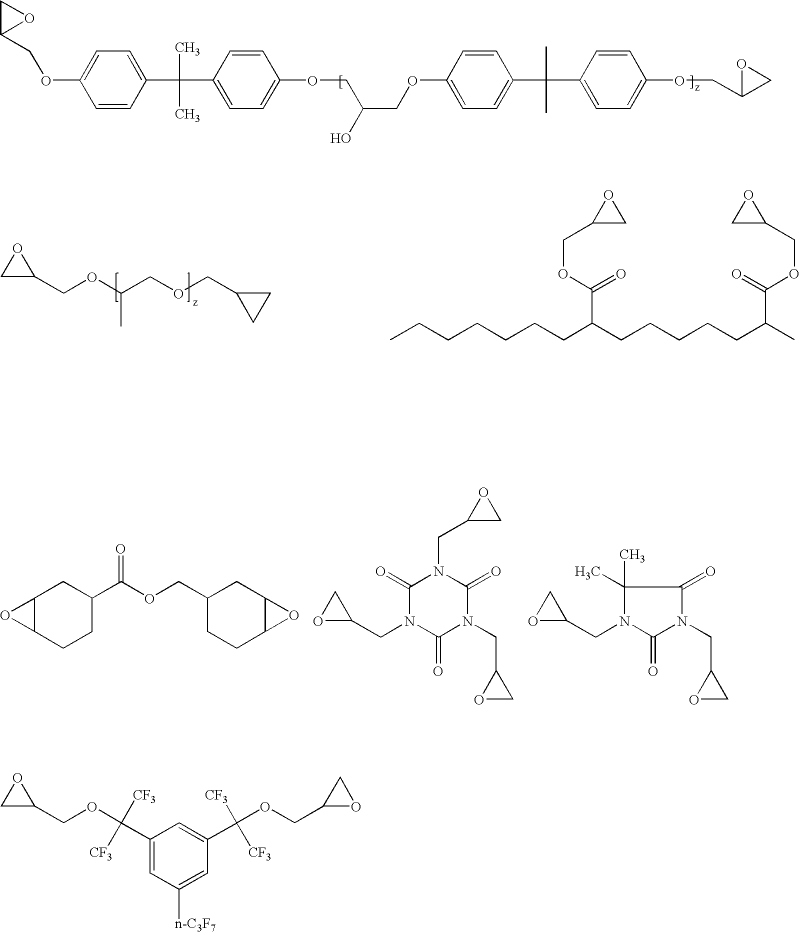
where z is in each case an integer in the range from 0 to 10.

Step (a) may be followed by a step (b) where textile treated as per step (a) is dried. This optional drying (b) can be carried out in commonly used apparatus, for example drying cabinets, or else in the open air. Temperatures in the range from 30° C. to 120° C. are sensible and temperatures from 70 to 110° C. are preferred. The drying time is customarily dependent on the drying temperature and on the desired residual moisture content and can be in the range from 30 seconds to 3 hours, although longer or shorter times are possible as well.

When step (a) is carried out more than once, every treatment step (a) may be followed by drying or preferably only the last treatment step (a).

The optional step (c) of the process according to the present invention comprises saponification of some or all of the amide groups. The amide groups referred to are the amide groups of the polymer(s) or copolymer(s) which were applied to the textile as per step (a) and which are obtainable by polymerization or copolymerization of N-vinylamide of the general formula I.

At least one of the steps (a2) and (c) is carried out within the framework of the present invention. That is, cellulosic textile can be treated with partially hydrolyzed polymer or copolymer of N-vinylamide of the general formula I and no step (c) carried out, or step (c) can be carried out and a partial hydrolysis according to (a2) omitted.

One embodiment of the present invention comprises treating cellulosic textile with a solution of polymer or copolymer obtainable by polymerization or copolymerization of N-vinylamide of the general formula I and partially hydrolyzed as per step (a2), optionally drying according to step (b) and subsequently saponifying some or all of the amide groups as per step (c).

One embodiment of the present invention comprises step (c) being carried out by treated and if appropriate dried textile being treated with dilute aqueous alkali metal hydroxide solution or aqueous alkali metal carbonate solution, preferably with aqueous sodium hydroxide solution, aqueous potassium hydroxide solution, sodium carbonate solution or potassium carbonate solution. Suitable concentrations are for example in the range from 0.5% to 10% by weight and preferably in the range from 2% to 5% by weight.

One embodiment has the temperature at which step (c) is carried out in the range from room temperature to 90° C., and preferably in the range from 70 to 90° C.

The pressure conditions of step (c) are not critical in that it can be carried out at atmospheric pressure for example, but pressures from 1.1 bar to 10 bar for example are likewise conceivable.

Step (c) can be carried out in the form of a continuous or batch process.

Step (c) typically comprises saponifying some of the amide groups at least.

One embodiment of the present invention comprises saponifying a third or more of the amide groups of the polymer(s) or copolymer(s) from step (a), preferably 90 mol % or more and more preferably 95 mol % or more.

One embodiment of the present invention comprises saponifying the amide groups of the polymer(s) or copolymer(s) from step (a) quantitatively.

It will be appreciated that it is within the framework of the present invention for step (c) to be followed by neutralizing steps, preferably with organic acids such as for example citric acid, tartaric acid, adipic acid or succinic acid. Similarly, within the framework of the present invention, step (c) may be followed by rinsing and drying steps.

If the pretreatment of the invention has been performed in the presence of one or more fixatives then it is preferred to follow the pretreatment by a fixing step (d), a thermal fixing step for example. By way of example it is possible to carry out fixing at temperatures of 150° C. to 190° C. over a period of 30 seconds to 5 minutes. The fixing step (d) is suitable on all fixing and drying units customary in the textile industry, such as on tentering frames and in drying cabinets, for example, using circulating air, for example.

The present invention provides in a further aspect a cellulosic textile pretreated by the process of the present invention. It is particularly useful for producing dyed textile. A further aspect of the present invention accordingly provides for the use of cellulosic textile which has been pretreated according to the present invention to produce dyed textile.

A further aspect of the present invention provides a process for producing dyed textile, hereinafter also referred to as inventive dyeing process. The inventive dyeing process starts with cellulosic textile which has been pretreated according to the present invention and comprises at least one dyeing step using at least one reactive, vat or direct dye, the choice of the reactive, vat or direct dye or dyes not being critical.

The inventive dyeing process can be carried out for example at atmospheric pressure or at pressures from 1.1 to 20 bar. It is preferred that the inventive dyeing process be carried out at atmospheric pressure.

The inventive dyeing process can be carried out for example at temperatures in the range from room temperature to 100° C. while temperatures in the range from 50 to 90° C. are preferred. To conduct the inventive dyeing process at pressures from 1.1 to 20 bar, temperatures in the range from 100 to 130° C. are conceivable.

The inventive dyeing process can be carried out in an aqueous dyeing liquor, in which case a liquor ratio and concentration of the reactive, vat or direct dye or dyes can be in customary dyehouse orders of magnitude.

In one embodiment of the dyeing process of the invention the dyeing liquor can be admixed with usual amounts of inorganic salts, examples being alkali metal or alkaline earth metal salts such as halides, carbonates or sulfates, preferably NaCl or Na₂SO₄. Usual amounts of inorganic salts may be, for example, 60 to 80 g/l of dyeing liquor.

In one preferred embodiment of the present invention the dyeing liquor contains in the range from 0 to 20 g/l of inorganic salts such as, for example, NaCl or Na₂SO₄, in particular up to 15 g/l.

Improved exhaustion of the dyeing liquor is observed. Cuts through textile dyed according to the present invention show uniform through-dyeing and virtually no ring dyeing. Textile which has been dyed in accordance with the present invention retains a bright color after prolonged mechanical wear and tear and multiple washes. Additionally it is possible to forego the use of high-salt-content dyeing liquors and yet still to obtain good dyeing results.

It will be appreciated that it is within the framework of the present invention for the actual dyeing step to be followed by aftertreatment steps customary in the dyeing arts; examples are aftersoaping steps, rinsing steps, drying steps and also finishing steps.

Practice of the inventive dyeing process provides an inventive dyed cellulosic textile which is likewise an aspect of the present invention.

Inventive dyed cellulosic textile is very useful for producing brightly colored robust substrates, for example pants, which exhibit a bright color after mechanical stressing and repeated washing.

The invention is illustrated by working examples.

### EXAMPLES 1 TO 16 AND COMPARATIVE EXAMPLE V1

I. Substances Used

I.1. Preparation of poly-N-vinylformamide (homopolymers)

Poly-N-vinylformamide was prepared by free radical polymerization, cf. “Kinetics and modelling of free radical polymerization of N-vinylformamide”, L. Gu, S. Zhu, A. N. Hrymak, R. H. Pelton, Polymer 2001, 42, 3077.

Hydrolysis or to be more precise partial hydrolysis is subsequently carried out at 80° C. using 25% by weight of aqueous sodium hydroxide solution.

The molecular weight was determined by gel permeation chromatography (GPC) using a polystyrene standard. The degree of hydrolysis was determined titrimetrically.

TABLE 1
Overview of poly-N-vinylformamides illustratively
used in step (a) of inventive pretreatment process

| | Hydrolyzed amide groups | |
|---|---|---|
| Polyvinylformamide | after step (a2) [mol %] | M_{w}[g/mol] |
| P1 | 0 | 30 000 |
| P2 | 10 | 400 000 |
| P3 | 30 | 400 000 |
| P4 | 60 | 400 000 |
| P5 | 0 | 400 000 |

I.2. Preparation of Copolymers of N-vinylformamide
Preparation P7

A 2-liter three-necked flask was charged with 550 g of distilled water and 34 g of N-vinylimidazole and this initial charge was heated to 75° C. Over the course of 2 hours with stirring a mixture of 138.8 g of N-vinylformamide and 170 g of N-vinylpyrrolidone was added dropwise. At the same time the dropwise addition was commenced of a solution of 1.7 g of azobisisobutyronitrile in 100 g of distilled water. After 3 hours the addition of the aqueous solution of azobisisobutyronitrile and of the mixture of N-vinylformamide and N-vinylpyrrolidone was at an end. Stirring was continued at 75° C. for two hours to give a clear, colorless, viscous solution. M_{w} (GPC): 620 000 g/mol, solids content: 20.1% by weight.

To prepare P6, P8 and P9 the procedure adopted was in each case as described above, the total amount of comonomers being 342.8 g in each case, and in each case N-vinylimidazole being included in the initial charge and the N-vinylformamide and/or N-vinylpyrrolidone comonomer or comonomers being added. The molecular weights are given in Table 1a.

The copolymers in question are each random copolymers.

TABLE 1a
Overview of poly-N-vinylformamide copolymers illustratively
used in step (a) of inventive pretreatment process

| Polyvinylformamide | Comonomers [% by weight] | | | |
|---|---|---|---|---|
| copolymer | VFA | NVP | NVI | M_{w}[g/mol] |
| P6 | 80 | — | 20 | 580 000 |
| P7 | 40 | 50 | 10 | 620 000 |
| P8 | 90 | — | 10 | 590 000 |
| P9 | 20 | 40 | 40 | 610 000 |

Abbreviations: NVFA: N-vinylformamide, NVP: N-vinylpyrrolidone, NVI: N-vinyl-imidazole
Amounts in % by weight are based in each case on the total mass of poly-N-vinylformamide copolymer
P8 was used as an aqueous solution with a solids content of 19.7% by weight, P9 as an aqueous solution with a solids content of 25.1% by weight.

I.3. Dyes Used:

Dye 1: hexasodium salt of hereinbelow depicted dye:

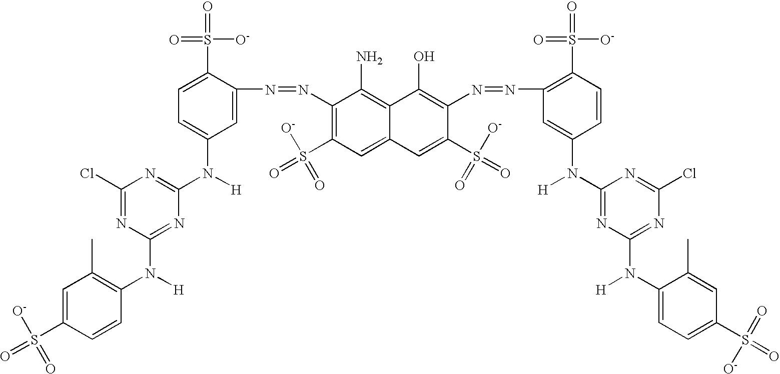

Dye mixture 2: 33.3% by weight each of

Colour Index Reactive Yellow 208

Colour Index Reactive Red 268

Colour Index Reactive Blue 263

Dye mixture 3: 33.3% by weight each of

Colour Index Reactive Orange 84

Colour Index Reactive Red 141

Colour Index Reactive Blue 160

Dye 4:

Colour Index Reactive Blue 71

Dye 5:

Octasodium salt of 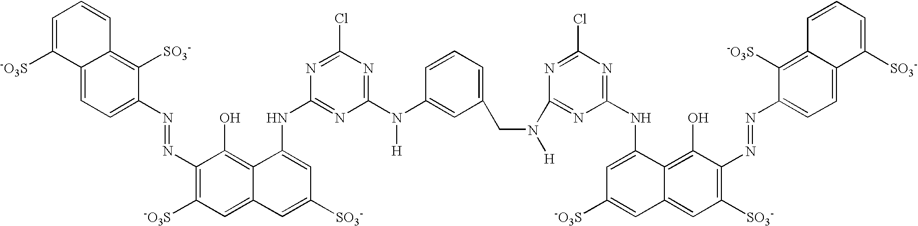
Dye 6: Pentasodium Salt of 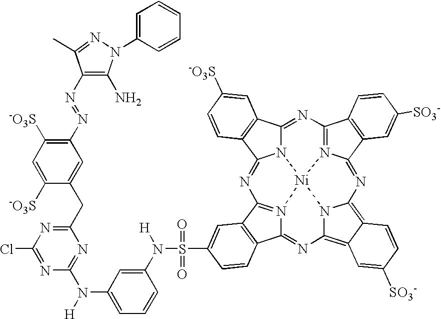
I.4. Fixatives Used

Fixative F1: methylpolyethylene glycol-modified trimeric hexamethylene diisocyanate prepared as per EP-B 0 206 059, examples 1 and 2, as 70% strength by weight solution in propylene carbonate. Amounts used are based in each case on total solution.

Fixative F2: trimethylolpropane tris(beta-aziridino)propionate

II. General Protocols for Inventive Pretreatment of Cellulosic Fabric with poly-N-vinylformamide and for Dyeing

II.1. General Protocol for Inventive Pretreatment of Woven Cellulosic Fabric with poly-N-vinylformamide

X g of poly-N-vinylformamide as per Tables 1 and 2 was dissolved in 100 ml of water.

The resultant polymer solution was subsequently used on a pad-mangle (from Mathis, model No. HVF12085) to drench a cellulosic textile (100% cotton woven, basis weight 160 g/m², bleached, ready to dye). The wet pickup was between 50% and 85% by weight, on weight of fiber. The fabric was subsequently dried at 80° C. for 5 minutes.

The textile pretreated according to the present invention was then treated with 3 g/l of aqueous sodium hydroxide solution at 70° C. in a liquor ratio of 20:1, then rinsed twice with water at 25° C. and subsequently neutralized with an aqueous solution containing 1.5 g/l of citric acid (liquor ratio in each case 20:1, treatment time 10 min at 30° C.). The textile treated according to the present invention was dried in a circulating air drying cabinet at 95° C.

The comparative example was carried out by following the above protocol but omitting poly-N-vinylformamide.

II.2 General Protocol for Dyeing the Pretreated Woven Cellulosic Fabric from II.1

An aqueous dyeing liquor was prepared from 1 g/l of reactive dye, 1 g/l of 1-hydroxymethylidenebisphosphonic acid, 1 g/l of sodium paranitrobenzenesulfonate and 60 g/l of sodium chloride and water. 100 ml of dyeing liquor was entered with 10 g of textile pretreated according to the present invention and transferred into a dyeing bomb. The dyeing bomb was sealed and placed in a dyeing apparatus (Ahiba Labomat) which had been preheated to 50° C. This was followed by heating to 82° C. in the course of 15 min and dyeing at 82° C. for a further 30 min. The dyeing bomb was then removed from the dyebath, opened and the dye liquor was admixed with 1.5 g of Na₂CO₃, dissolved in 10 ml of water and homogenized. The dyeing bomb was then sealed, placed in the dyeing apparatus and maintained at 82° C. for a further 60 min to fix the dye. This was followed by cooling to about 30° C. for 5 minutes, when the dyeing bomb was opened and the textile dyed according to the present invention was removed and then rinsed under running water at 60 to 70° C. for 5 min.

After rinsing, the textile dyed according to the present invention was soaped off with a solution of 2 g/l of sodium polyacrylate (M_{w} 70 000 g/mol) at a pH of 8.5 for a period of 15 min at 98° C. in a liquor ratio of 10:1. This was followed by rinsing under running water for 5 min at 60 to 70° C. and then for another 5 min at 20 to 35° C. and thereafter 20 minutes of drying at 80° C. in a circulating air drying cabinet.

This provided an inventive dyed textile as per Example 1 to 16 (Table 2) and a comparative textile as per Comparative Example V1. The inventive textiles as per Example 1 to 16 exhibited a brilliant dyeing. Cuts showed that the fibers—unlike those of the comparative textile as per Comparative Example V1—were uniformly through-dyed and did not exhibit ring dyeing.

TABLE 2
Results of inventive pretreatment process, of inventive dyeing
process and of comparative experiments (V1) with dye 1

| | Example No. | | | | |
|---|---|---|---|---|---|
| | V1 | 1 | 2 | 3 | 4 |
| Poly-N-vinylformamide | — | P1 | P1 | P1 | P1 |
| Amount used X [g] | — | 0.625 | 1.25 | 2.5 | 5.0 |
| Wet pickup [wt %] | — | 80 | 80 | 80 | 80 |
| Washfastness (ISO 105 C03) | 4-5 | 5 | 5 | 5 | 5 |
| Depth of shade (V1 = 100%) | 100 | n.d. | n.d. | n.d. | 135.1 |

| | Example No. | | | |
|---|---|---|---|---|
| | 5 | 6 | 7 | 8 |
| Poly-N-vinylformamde | P2 | P2 | P2 | P2 |
| Amount used X [g] | 0.625 | 1.25 | 2.5 | 5.0 |
| Wet pickup [wt %] | 80 | 80 | 80 | 80 |
| Washfastness (ISO 105 C03) | 4-5 | 4-5 | 5 | 5 |
| Depth of shade (V1 = 100%) | n.d. | n.d. | n.d. | 137.2 |
| | Example No. | | | |
| | 9 | 10 | 11 | 12 |
| Poly-N-vinylformamde | P3 | P3 | P3 | P3 |
| Amount used X [g] | 0.625 | 1.25 | 2.5 | 5.0 |
| Wet pickup [wt %] | 80 | 80 | 80 | 80 |
| Washfastness (ISO 105 C03) | 5 | 4-5 | 5 | 5 |
| Depth of shade (V1 = 100%) | n.d. | n.d. | n.d. | 139.0 |
| | Example N. | | | |
| | 13 | 14 | 15 | 16 |
| Polymer | P4 | P4 | P4 | P4 |
| Amount used X [g] | 0.625 | 1.25 | 2.5 | 5.0 |
| Wet pickup [wt %] | 80 | 80 | 80 | 80 |
| Washfastness (ISO 105 C03) | 4-5 | 5 | 5 | 5 |
| Depth of shade (V1 = 100%) | n.d. | n.d. | n.d. | 135.6 |

| | Example No. | | | | |
|---|---|---|---|---|---|
| | 17 | 18 | 19 | 20 | 21 |
| Poly-N-vinylformamde | P5 | P5 | P5 | P5 | P5 |
| Amount used X [g] | 5.0 | 5.0 | 5.0 | 5.0 | 5.0 |
| Dye/Dye mixture No. | 2 | 3 | 4 | 5 | 6 |
| Amount used of dye/dye mixture | 6 | 6 | 2 | 2 | 2 |
| [wt %] | | | | | |
| Washfastness (ISO 105 C03) | 4-5 | 5 | 5 | 4-5 | 5 |
| Wet pickup [wt %] | 80 | 80 | 80 | 80 | 80 |
| Washfastness (ISO 105 C03) | 4-5 | 5 | 5 | 4-5 | 4-5 |
| Depth of shade [%] | 108 | 112 | 108 | 106 | 107 |

n.d.: not determined
The depth of shade of a dyed textile sample which had been pretreated without a polymer is set at 100% in each case.

III. General Protocols for Inventive Pretreatment of Cellulosic Textile Using poly-N-vinylformamide Copolymer
III.1. Inventive Pretreatment Without Fixative

50 g of poly-N-vinylformamide copolymer and 50 g of aqueous solution of poly-N-vinylformamide copolymer according to Table 1a, respectively, were made up With water to 1000 ml of dyeing liquor. Subsequently a pad-mangle (manufacturer Mathis, model No. HVF12085) was used to impregnate a cellulosic textile (100% cotton woven, basis weight 160 g/m², bleached, ready for dyeing) with the dyeing liquor thus obtained. The liquor add-on was between 50% and 85% by weight, based on the weight of the goods. Subsequently the pretreated textile was dried at 80° C. for 5 minutes.

III.2 Inventive Pretreatment with Fixative

50 g of poly-N-vinylformamide copolymer and 50 g of aqueous solution of poly-N-vinylformamide copolymer according to Table 1a and 1.5 g of fixative as per Table 3 respectively, were made up with water to 1000 ml of dyeing liquor. Subsequently a pad-mangle (manufacturer Mathis, model No. HVF12085) was used to impregnate a cellulosic textile (100% cotton woven, basis weight 160 g/m², bleached, ready for dyeing) with the dyeing liquor thus obtained. The liquor add-on was 80% by weight, based on the weight of the goods. Subsequently the pretreated textile was dried at 160° C. for 3 minutes and so thermally fixed.

III.3 Dyeing of Pretreated Textile from II.1 and II.2

An aqueous dyeing liquor was prepared from 2 g/l of dye No. 4, 1 g/l of 1-hydroxymethylidenebisphosphonic acid, 1 g/l of para-nitrobenzenesulfonic acid sodium salt, sodium chloride as per Table 3, and water. 10 g of inventively pretreated textile were added to 100 ml of dyeing liquor and the mixture was transferred to a dyeing bomb. The dyeing bomb was sealed and inserted into a dyeing apparatus (Ahiba Labomat) preheated at 50° C. It was subsequently heated to 82° C. over the course of 15 minutes, followed by dyeing at 82° C. for a further 30 minutes. The dyeing bomb was then removed from the dyeing bath, opened, 1.5 g of Na₂CO₃ in solution in 10 ml of water were added to the dyeing liquor, and the mixture was homogenized. The dyeing bomb was then sealed, inserted into the dyeing apparatus and held at 82° C. for a further 60 minutes in order to fix the dye. This was followed by cooling to about 30° C. over the course of 5 minutes, opening of the dyeing bomb and withdrawal of the inventively dyed textile, which was then rinsed under running water at 60 to 70° C. for 5 minutes.

After it had been rinsed the inventively dyed textile was soaped in a 10:1 liquor-to-goods ratio with a solution of 2 g/l polyacrylic acid Na salt (M_{w} 70 000 g/mol) at a pH of 8.5 for a time of 15 minutes at 98° C. Following this it was rinsed once at 60 to 70° C. for 5 minutes and then at 20 to 35° C. for 5 minutes under running water, followed by drying at 80° C. for 20 minutes in a circulating air drying cabinet.

The comparative examples were carried out by starting in each case from unpretreated textile.

This produces inventively dyed textile according to Example 17 to 24 (Table 3) and comparison textiles according to Comparative Examples V2 to V6 (Table 4). The inventive textiles according to Example 17 to 24 exhibited brilliant dyeing. Sections showed that the fibers—in contradistinction to what was the case for the comparison textile according to Comparative Examples V2 to V6—was uniformly through-dyed and showed no ring dyeing.

The values for L, A, B and delta E were determined in accordance with CIELAB.

TABLE 3
Dyeing of pretreated textile

| | Example No. | | | |
|---|---|---|---|---|
| | 17 | 18 | 19 | 20 |
| Poly-N-vinylformamide copolymer | P6 | P7 | P8 | P9 |
| Sodium chloride [g/l] | 20 | 20 | 20 | 20 |
| Fixative | — | — | — | — |
| L | 56.48 | 56.85 | 57 | 55.51 |
| A | −28.08 | −28.26 | −27.53 | −27.23 |
| B | −34.26 | −34.42 | −32.87 | −33 |
| Delta E | 0.93/5 | 1.27/5 | 0.8/3 | 1.34/3 |
| | Example No. | | | |
| | 17 | 18 | 19 | 20 |
| Poly-N-vinylformamide copolymer | P8 | P9 | P8 | P9 |
| Sodium chloride [g/l] | 20 | 20 | 0 | 20 |
| Fixative | F1 | F1 | F2 | F2 |
| L | 55.56 | 54.3 | 56 | 52.99 |
| A | −27.33 | −26.11 | −27.22 | −26.22 |
| B | −34.16 | −33.5 | −34.29 | −35.79 |
| Delta E | 1.36/3 | 1.32/4 | 1.21/3 | 1.97/4 |

TABLE 4
Comparative Examples: Dyeing of unpretreated textile

| | Example No. | | | | |
|---|---|---|---|---|---|
| | V2 | V3 | V4 | V5 | V6 |
| Poly-N-vinylformamide | — | — | — | — | — |
| copolymer | | | | | |
| Sodium chloride [g/l] | — | 20 | 40 | 80 | 70 |
| Fixative | — | — | — | — | — |
| L | 64.07 | 60.54 | 56.59 | 53.94 | 55.75 |
| A | −27.79 | −28.54 | −27.88 | −27.09 | −28.43 |
| B | −29.23 | −31.39 | −33.46 | −34.3 | −33.8 |
| Delta E | — | — | — | — | — |

1. A process for pretreating cellulosic textile, which comprises the steps of:
(a) treating cellulosic textile with a solution of polymer or copolymer obtainable by
(a1) polymerization or copolymerization of N-vinylamide of the general formula I, 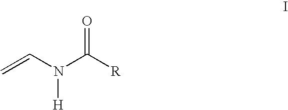
where
comonomers of N-vinylamide are selected from (meth)acrylates, N-vinylpyrrolidone, N-vinylimidazole, ethylene, propylene, 1-butene and 1,3-butadiene,
R is selected from hydrogen and C₁-C₁₀-alkyl, and
(a2) partial hydrolysis if appropriate,
(b) optionally drying the treated textile, and
(c) optionally saponifying all or some of the amide groups,
wherein at least one of the steps (a2) and (c) is carried out.

2. The process according to claim 1 that utilizes aqueous solution of polymer or copolymer.

3. The process according to claim 1 wherein R represents hydrogen in the general formula I.

4. The process according to claim 1 wherein the polymer or copolymer obtainable by polymerization or copolymerization of N-vinylamide of the general formula I has an M_{w} in the range from 10,000 to 1,000,000 g/mol.

5. The process according to claim 1 wherein the copolymer is obtainable
by (a1) copolymerization of N-vinylamide of the general formula I
with at least one further comonomer selected from N-vinylpyrrolidone and N-vinylimidazole.

6. The process according to claim 1 that utilizes polymer or copolymer obtainable by
(a1) polymerization or copolymerization of N-vinylamide of general formula I and
(a2) subsequent partial hydrolysis.

7. Cellulosic textile pretreated by a process according to claim 1.

8. The method of using cellulosic textile pretreated by a process according to claim 1 for producing dyed textile.

9. A process for producing dyed cellulosic textile, which comprises dyeing pretreated cellulosic textile according to claim 7 with reactive, vat or direct dye.

10. The process according to claim 9 wherein the dyeing liquor comprises from 0 to 20 g/l of one or more inorganic salts.

11. Dyed cellulosic textile obtainable by a process according to claim 9.
